(19) United States
(12) Patent Application Publication
(10) Pub. No.: US 2009/0228637 A1
(43) Pub. Date: Sep. 10, 2009

(54) HIGH-SPEED SOLID STATE STORAGE SYSTEM HAVING A HIERARCHY OF DIFFERENT CONTROL UNITS THAT PROCESS DATA IN A CORRESPONDING MEMORY AREA AND METHOD OF CONTROLLING THE SAME

(76) Inventors: Yang Gi MOON, Ichon-si (KR); Dae Hee YI, Seoul (KR)

Correspondence Address: LADAS & PARRY LLP, 224 SOUTH MICHIGAN AVENUE, SUITE 1600, CHICAGO, IL, 60604, US

(21) Appl. No.: 12/344,728

(22) Filed: Dec. 29, 2008

(30) Foreign Application Priority Data
Mar. 10, 2008 (KR) 10-2008-0022206

(51) Int. Cl. G06F 12/02

(52) U.S. Cl. 711/103; 711/E12.008

(57) ABSTRACT

A solid state storage system having a hierarchy of different control units that systematically process data in a corresponding memory area is disclosed. The solid state storage system includes
a first control unit and at least one second control unit. The first control unit distributes and transmits external command signals that are provided from a host interface. The second control unit is controlled by the first control unit and performs an address mapping operation, an error checking/correcting operation, an ad defective block managing operation on a corresponding plurality of memory chips in the memory area.

### CROSS-REFERENCES TO RELATED APPLICATION

The present application claims priority under 35 U.S.C. §119(a) to Korean application number 10-2008-0022206, filed on Mar. 10, 2008, in the Korean Intellectual Property Office, which is incorporated herein by reference in its entirety as if set forth in full.

### BACKGROUND OF THE INVENTION

1. Technical Field

The present invention relates to a solid state storage system and a method of controlling the same, and more particularly, to a high-speed solid state storage system and a method of controlling the same.

2. Related Art

In general, non-volatile memories have been used for portable information apparatuses. For example, as memories that are used to store codes for data processing in mobile phones and MP3s, NOR flash memories have been mainly used, in which high-speed operations and a random access features are enabled. Although NOR flash memories enable high-speed operations and random access, they suffer from a relatively high manufacturing cost per unit capacity. For this reason, the NOR flash memories are not often used as large-capacity memories. Meanwhile, as well known, NAND flash memories exhibit lower operation speeds than that of comparable NOR flash memories, but NAND flash memories do enjoy relatively lower manufacturing cost per unit capacity. For this reason, the NAND flash memories have been increasingly preferred as image data storage in digital cameras or the like. In recent years, instead of a hard disk drive (HDD), a solid state drive (SSD) using a NAND flash memory has begun to be used in a PC. Therefore, it is anticipated that the SSD will make inroads into the share market of the HDD. However, in an existing NAND flash application system, the entire system performance depends on the operation speed of the NAND flash memory that functions at relatively slower speeds. As a result, the system performance is degraded. Accordingly, a method that allows the NAND flash memory to operate at a high speed would be welcomed.

### SUMMARY OF THE INVENTION

The invention has been finalized in order to solve the above-described problems. An embodiment of the invention provides a solid state storage system that can operate at relatively high speeds.

Another embodiment of the invention provides a method of controlling a solid state storage system that can operate at the high speeds.

According to an embodiment of the invention, a solid state storage system includes: a first control unit that distributes and transmits signals that are provided from a host interface; and a second control unit that is controlled by the first control unit and performs an address mapping operation, an error checking/correcting operation, and a defective block managing operation on a plurality of memory chips.

According to another embodiment of the invention, a solid state storage system includes: a host interface; a first control unit which responds to signals transmitted from the host interface; a buffer unit which is interposed between the host interface and the first control unit, and buffers output signals from the host interface or output signals from the first control unit; a second control unit which is activated by the first control unit and directly controls the operation of a memory area; and the memory area which is controlled by the second control unit and inputs/outputs data.

According to still another embodiment of the invention, there is provided a method of controlling a solid state storage system. The method includes: allowing a command, which is received from a host interface, to be simultaneously transmitted to a plurality of sub-control units; allowing the individual sub-control units to perform an address mapping operation on corresponding memory chips; when an error occurs while the operation of the corresponding memory chips is performed, allowing the individual sub-control units to perform an error checking/correcting process; and when an error does not occur while the operation of the corresponding memory chips is performed, allowing the individual sub-control units to execute a next command.

According to the embodiments of the invention, a plurality of memory chips can be driven while the load of the system can be reduced in response to a command provided from a host interface. In addition to a main control unit that exchanges a signal with the host interface so as to drive the memory chips, a plurality of control units, which are controlled by the main control unit, are additionally provided. Therefore, the load of the system can be reduced. As a result, it is possible to implement a high-speed operation of a solid state storage system.

### BRIEF DESCRIPTION OF THE DRAWINGS

FIG. 1 is a conceptual block diagram illustrating a solid state storage system according to an embodiment of the invention;

FIG. 2 is a block diagram illustrating a relationship between a second control unit and a memory area shown in FIG. 1;

FIG. 3 is a block diagram illustrating a first sub-control unit shown in FIG. 2;

FIG. 4 is a block diagram illustrating a second control unit and a memory area according to another embodiment of the invention;

FIG. 5 is a block diagram illustrating a second control unit and a memory area according to still another embodiment of the invention; and

FIG. 6 is a flowchart illustrating a method of controlling a solid state storage system shown in FIG. 1.

### DESCRIPTION OF EXEMPLARY EMBODIMENTS

Hereinafter, a solid state storage system according to an embodiment of the invention will be described in detail with reference to the accompanying drawings.

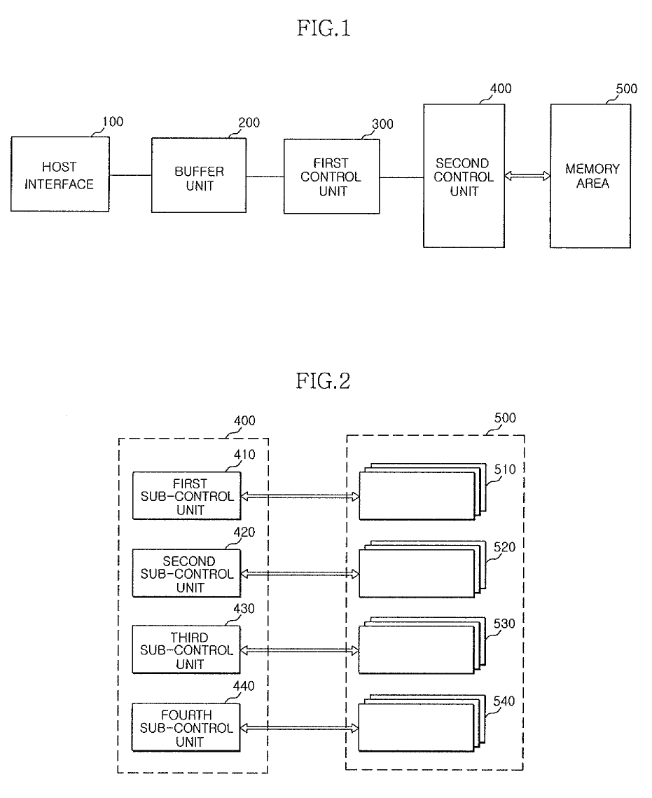

FIG. 1 is a block diagram illustrating a solid state storage system 1 according to an embodiment of the invention.

Referring to FIG. 1, the solid state storage system 1 includes a host interface 100, a butter unit 200, a first control unit 300, a second control unit 400, and a memory area 500.

First, the host interface 100 is connected to the buffer unit 200 and transmits and receives control commands, address signals, and data signals between an external host (not shown) and the buffer unit 200. An interface scheme between the host interface 100 and the external host (not shown) can be any one of a serial advanced technology attachment (SATA) scheme, a parallel advanced technology attachment (PATA) scheme, and a PCI-Express scheme, but the invention is not limited thereto.

The buffer unit 200 buffers output signals from the host interface 100 or output signals from the first control unit 300 and provides the buffered signals to the host interface 100. That is, the buffer unit 200 is interposed between the host interface 100 and the first control unit 300, and can compensate for a response speed and time between the host interface 100 and the first control unit 300.

The first control unit 300 receives the control commands, the address signals, and the data signals, which are transmitted through the buffer unit 200 from the host interface 100, and provides the control commands, the address signals, and the data signals to the second control unit 400.

The first control unit 300 according to this embodiment includes a micro controller unit (MCU) (not shown). The first control unit 300 functions as a main interface controller between the host interface 100 and the memory area 500.

In particular, the first control unit 300 provides the control commands, the address signals, and the data signals transmitted from the host interface 100 to the second control unit 400.

The first control unit 300 directly controls the operation of memory chips of the memory area 500 in response to the command from the host interface 100. Accordingly, one first control unit 300 directly controls driving of a plurality of memory chips. Since the first control unit 300 exchanges the signals with the host interface 100 and directly controls the memory area 500, then the first control unit 300 can become overloaded. Specifically, when one first control unit 300 controls a read operation of the individual memory chips, the first control unit 300 needs to perform an FTL conversion operation, a defective block management operation, and an error checking/detecting operation for every memory chip. In addition, the first control unit 300 needs to exchange the signals with the host interface 100. Accordingly, due to limited performance and finite operation speed of the first control unit (refer to reference numeral 300 of FIG. 1), it is difficult for one first control unit to securely perform various control operations.

However, according to this embodiment, the first control unit 300 does not directly control the memory chips of the memory area 500, and activates only the second control unit 400 in response to the command signal from the host interface 100. That is, the first control unit 300 controls the second control unit 400 and the second control unit 400 controls the operation of the memory area 500. Accordingly, it is possible to implement the distributing of tasks.

In the related art, since the first control unit 300 directly controls the operation of the memory area 500, time is needed when the buffer unit 200 buffers the signals is substantially the same as command execution time in the memory area 500. That is, while the operation of the memory area 500 is performed, the first control unit 300 checks whether there is an error and corrects the error, and performs a control operation such that a read/write operation is performed. Thus, the buffer unit 200 buffers the signals within the minimal error checking/correcting time or data processing time of one sector, receives a next command from the host interface 100, and transmits the next command to the first control unit 300.

However, according to this embodiment, the second control unit 400 determines whether an error is checked in the memory area 500 and performs the other control operations. Thus, the command buffering time of the buffer unit 200 becomes substantially shorter than the command buffering time in the related art. That is, time, which is needed when the command signals and data are exchanged between the buffer unit 200 and the first control unit 300, can be approximately transmission time that corresponds to a word unit. The data that has been received by the first control unit 300 is data on which error checking is completed. Thus, the buffer unit 200 does not need to consume error checking time or FTL conversion time of an address by the first control unit 300.

The second control unit 400 according to the embodiment of the invention that has been described above is controlled by the first control unit 300 and can directly control the operation of memory chips of the memory area 500.

Specifically, the second control unit 400 can perform an address mapping operation, a defective block managing operation, and a wear leveling data and error checking/correcting operation on the memory chips in the memory area 500, in response to the command from the first control unit 300.

The memory area 500 is controlled by the second control unit 400 and data can be processed in parallel in the memory area 500. Accordingly, it is possible to process data at high speeds in the memory area 500.

The above will be described in detail below with reference to the following drawings.

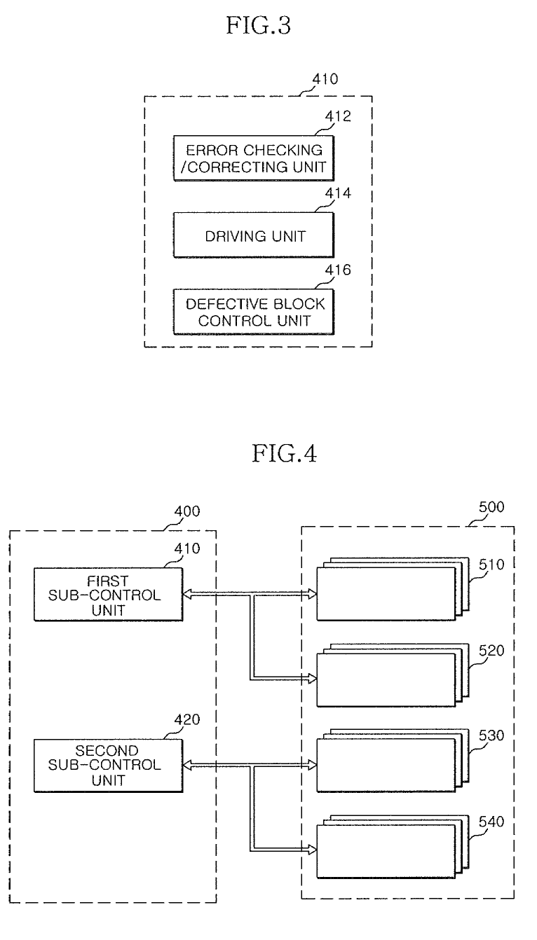

FIG. 2 is a block diagram illustrating a relationship between a second control unit 400 and a memory area 500. FIG. 3 is a block diagram illustrating the detailed structure of a first sub-control unit 410.

Referring to FIGS. 2 and 3, the second control unit 400 includes first to fourth sub-control units 410 to 440.

The memory area 500 includes first to fourth memory groups 510 to 540. Each of the first to fourth memory groups 510 to 540 includes a plurality of grouped memory chips. In this case, each memory chip is exemplified as a NAND flash memory.

The first sub-control unit 410, the second sub-control unit 420, the third sub-control unit 430, and the fourth sub-control unit 440 can control the operation of the first memory group 510, the operation of the second memory group 520, the operation of the third memory group 530, and the operation of the fourth memory group 540, respectively.

As shown in FIG. 3, the first sub-control unit 410 includes an error checking/correcting unit 412, a driving unit 414, and a defective block control unit 416. For convenience of explanation, only the first sub-control unit 410 is shown, but the second to fourth sub-control units 420 to 440 can be implemented to have the same structure as the first sub-control unit 410.

First, the error checking/correcting unit 412 can detect and correct an error while the operations of the memory groups 510 to 540 are performed. The error checking/correcting unit 412 according to the embodiment of the invention is exemplified as a common error checking/correcting unit, which is known by those skilled in the art. Accordingly, the detailed description of the error checking/correcting unit 412 will be omitted.

The driving unit 414 can provide a control signal that is related to address mapping or a read/write command. Specifically, the driving unit 414 performs an FTL conversion (Flash Memory Transfer Level) to convert a logical address into a physical address and controls address mapping. The driving unit 414 selects the memory chips of the memory groups 510 to 540 and substantially drives the memory chips. Meanwhile, although not shown in the drawings, each of the memory chips includes a plurality of read/write unit sectors (not shown). The driving unit 414 can select a sector (not shown) of a memory chip that is selected from the memory chips of the memory groups 510 to 540 and provide a signal that is related to a read/write command.

The defective block control unit 416 can substitute a defective block, which occurs while a command is executed, by a spare block in order to manage the defective block. As a result, the defective block control unit 416 can control equivalent blocks of the memory chips.

Therefore, the first to fourth sub-control units 410 to 440 can function as the first control unit (refer to reference numeral 300 of FIG. 1) according to the related art. That is, the first to fourth sub-control units 410 to 440 can perform an FTL conversion to convert a logical address of a sector (not shown) of the selected memory group into a physical address, and map the logical address to the physical address. When a defective block occurs with respect to the memory chip of the memory group, the first to fourth sub-control units 410 to 440 can substitute the defective block with a spare block and consequently manage the defective block. Further, the first to fourth sub-control units 410 to 440 perform a control operation such that the memory blocks are equally used in the memory area 500, and detect errors that can occur in the memory area 500.

Therefore, the solid state storage system includes the sub-control units 410 to 440 that are simultaneously driven by the first control unit (refer to reference numeral 300 of FIG. 1) and can directly control the first to fourth memory groups 510 to 540 of the memory area 500. Accordingly, parallel data processing can be performed without causing an overload in the solid state storage system.

Since the solid state storage system 1 distributes the function of the first control unit 300 to the first to fourth sub-control units 410 to 440, it is then possible to increase a command execution process speed and an operation speed as compared with the related art. Instead of using the related art in which one control unit performs a control operation on the host interface 100 and the memory area 500, a response speed can be increased if using this embodiment in which distribution processing is implemented. According to this embodiment, since only the second control unit 400 is additionally provided, the system can be easily extended without a complex change of the entire operation algorithm of the solid state storage system.

Each of the first to fourth sub-control units 410 to 440 can be either a NAND flash controller, a solid state drive (SSD), or a flash card, but the invention is not limited thereto. That is, each of the first to fourth sub-control units 410 to 440 can be composed of any type of controller that can perform an FTL conversion operation and a defective block managing operation, and implement an error detection and correction code (ECC).

Meanwhile, the memory chip of each of the first to fourth memory groups 510 to 540 can be composed of a single level chip (SLC) or a multi level chip (MLC). Further, the number of memory groups 510 to 540 and the number of sub-control units 410 to 440 corresponding thereto are four, respectively, but the invention is not limited thereto. The number of memory groups and the number of sub-control units can increase or decrease depending on the structure of the particular solid state storage system.

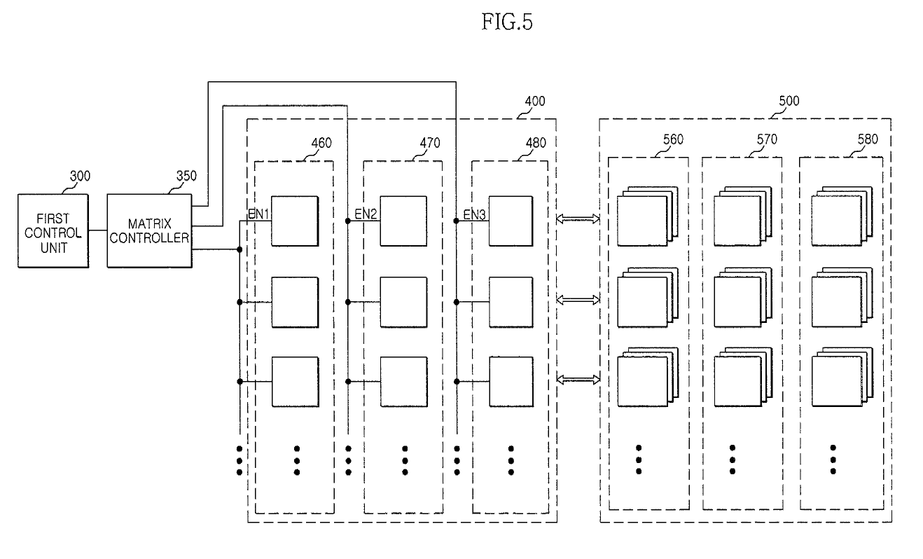

FIG. 4 is a block diagram illustrating a relationship between a second control unit 400 and a memory area 500 according to another embodiment of the invention.

Referring to FIG. 4, the second control unit 400 includes first and second sub-control units 410 and 420.

For example, each of the first and second memory groups 510 and 520 is a memory group that is composed of grouped SLC memory chips, and each of the third and fourth memory groups 530 to 540 is a memory group that is composed of grouped MLC memory chips. The first sub-control unit 410 can control the operation of the first and second memory groups 510 to 520, and the second sub-control unit 420 can control the operation of the third and fourth memory groups 530 and 540.

That is, since each of the first and second sub-control units 410 and 420 has a predetermined number of memory chips that can control the memory chips of the memory group, the above control scheme is possible. The solid state storage system 1 includes the second sub-control unit 420 that is a dedicated control unit for the third and fourth memory groups 530 and 540 whose operation speeds are relatively lower than those of the first and second memory groups 510 and 520. Therefore, the system speed can be improved. For convenience of explanation, the memory chips are divided into single level chips and multi-level chips and the individual memory groups are formed, but the invention is not limited thereto. That is, the memory chips can be divided into memory chips for a memory group for main code storage and a memory group for working data storage in accordance with a utilization object and individually controlled.

FIG. 5 is a block diagram illustrating a relationship between a first control unit 300, a second control unit 400, and a memory area 500 according to still yet another embodiment of the invention.

Referring to FIG. 5, a matrix controller 350 is interposed between the first control unit 300 and the second control unit 400. The second control unit 400 includes first to third sub-control groups 460 to 480.

The matrix controller 350 controls the sub-control groups 460 to 480. That is, the matrix controller 350 provides first to third enable signals EN1 to EN3 and can selectively drive the second control unit 400. Specifically, the matrix controller 350 can provide the first to third enable signals EN1 to EN3 that are selectively enabled in accordance with the predetermined signals transmitted from the first control unit 300. In this case, the predetermined signals can be chip selector (CS) signals. Accordingly, the first enable signal EN1, the second enable signal EN2, and the third enable signal EN3 enable the first sub-control group 460, the second sub-control group 470, and the third sub-control group 480, respectively.

That is, the first sub-control group 460, the second sub-control group 470, and the third sub-control group 480 receive the first enable signal EN1, the second enable signal EN2, and the third enable signal EN3, respectively.

The memory area 500 includes first to third memory blocks 560 to 580.

Each of the first to third memory blocks 560 to 580 can include a plurality of memory groups.

As a result, the first sub-control group 460, the second sub-control group 470, and the third sub-control group 480 can control the first memory block 560, the second memory block 570, and the third memory block 580, respectively.

As such, according to still yet another embodiment of the invention, the plurality of sub-control groups, each of which includes a plurality of sub-control units, are provided. Accordingly, it is possible to increase the number of memory groups that are controlled by each of the sub-control groups. Since the matrix controller 350 is included to control the sub-control groups, parallel data processing can be implemented.

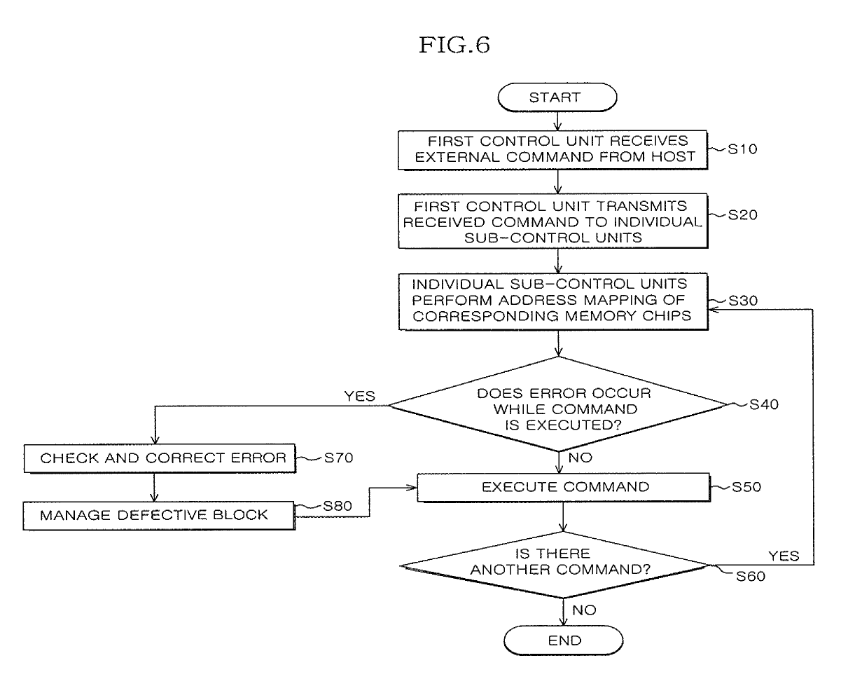

FIG. 6 is a flowchart illustrating a method of controlling a solid state storage system according to an embodiment of the invention.

Referring to FIGS. 1 to 6 again, the first control unit 300 receives external commands from the host interface 100 (S10).

The first control unit 300 transmits the received command signals to the first to fourth sub-control units 410 to 440 (S20).

As described above, the first control unit 300 transmits the command signals and the addresses, which are received from the host interface 100, to the first to fourth sub-control units 410 to 440 and drives the first to fourth sub-control units. That is, the first control unit 300 performs only the above control operation. In this way, the load on the first control unit 300 can be reduced. That is, since the first control unit 300 only transmits the command signals and the address signals to the individual sub-control units 410 to 440 and drives the individual sub-control units, overload is not generated in the first control unit 300.

The individual sub-control units 410 to 440 perform address mapping on the received addresses (S30).

Each of the sub-control units 410 to 440 can perform an FTL conversion to convert a logical address of the corresponding memory chip into a physical address.

When a command is executed in the corresponding memory chip, the error checking/correcting unit 412 determines whether there is an error (S40).

When it is determined that there is no error, the corresponding memory chip continuously performs the operation corresponding to the command (S50).

However, when it is determined that there is an error, the error checking/correcting unit 412 checks and corrects the error (S70), and the defective block control unit 416 manages a defective block (S80). Then, a read/write command is executed in the corresponding memory chip (S50).

When the command execution is completed, the first control unit 300 determines whether another command exists (S60). The first control unit 300 controls the individual sub-control units 410 to 440 and performs a control operation.

As such, according to the embodiments of the invention, the solid state storage system includes the first control unit 300 that is controlled by the host interface 100 and the second control unit 400 that is controlled by the first control unit 300 and directly controls the operation of the memory area 500. Therefore, the load on the first control unit 300 can be reduced. Since the number of sub-control units of the second control unit 400 can be increased, it is possible to increase the number of memory chips that can be controlled by the sub-control units.

It will be apparent to those skilled in the art that various modifications and changes can be made without departing from the scope and spirit of the invention. Therefore, it should be understood that the above embodiments are not limitative, but illustrative in all aspects. The scope of the invention is defined by the appended claims rather than by the description preceding them, and therefore all changes and modifications that fall within metes and bounds of the claims, or equivalents of such metes and bounds are therefore intended to be embraced by the claims.

What is claimed is:

1. A solid state storage system comprising:
a first control unit that distributes and transmits signals that are provided from a host interface; and
a second control unit controlled by the first control unit such that the second control unit performs an address mapping operation, an error checking/correcting operation, and a defective block managing operation on a plurality of memory chips.

2. The solid state storage system of claim 1,
wherein the second control unit includes a plurality of sub-control units that are simultaneously driven so as to control a plurality of groups of memory chips.

3. The solid state storage system of claim 1,
wherein the second control unit includes any one of a NAND flash controller, a solid state drive (SDD), and a flash card.

4. The solid state storage system of claim 1,
wherein each of the memory chips includes a NAND flash memory.

5. A solid state storage system comprising:
a host interface;
a first control unit that responds to signals transmitted from the host interface;
a buffer unit interposed between the host interface and the first control unit, such that the buffer unit buffers output signals from the host interface or output signals from the first control unit;
a second control unit activated by the first control unit such that the second control unit directly controls the operation of a memory area; and
the memory area controlled by the second control unit and inputs/outputs data.

6. The solid state storage system of claim 5,
wherein a signal transmission time, corresponding to an interval between the host interface and the first control unit via the buffer unit when a signal is transmitted, is shorter than a data processing time between the second control unit and the memory chips in processing data.

7. The solid state storage system of claim 5,
wherein the first control unit distributes and provides the signals, in response to external commands transmitted from the host interface through the buffer unit, to the second control unit to process the signals in processing data at the memory chips.

8. The solid state storage system of claim 5,
wherein the second control unit includes a plurality of sub-control units that are simultaneously driven.

9. The solid state storage system of claim 8,
wherein the sub-control units are associated to corresponding memory groups, such that each corresponding memory group includes a plurality of grouped memory chips.

10. The solid state storage system of claim 8,
wherein each of the sub-control units performs an address mapping operation, an error checking/correcting operation, and a defective block managing operation on a corresponding memory group having a plurality of grouped memory chips.

11. The solid state storage system of claim 8,
wherein each of the sub-control units includes any one of a NAND flash controller, a solid state drive (SSD), and a flash card.

12. The solid state storage system of claim 5,
wherein the memory area includes a NAND flash memory.

13. A method of controlling a solid state storage system, comprising:
allowing a command, which is received from a host interface, to be simultaneously transmitted to a plurality of sub-control units;
allowing individual sub-control units to perform an address mapping operation on corresponding memory chips;
allowing individual sub-control units to perform an error checking/correcting process when an error occurs while the operation of the corresponding memory chips is performed; and
allowing the individual sub-control units to execute a next command when an error does not occur while the operation of the corresponding memory chips is performed.

14. The method of claim 13, further comprising:
allowing a first control unit to receive a signal from the host interface before the plurality of sub-control units receive the command.

15. The method of claim 14,
wherein a signal transmission time between the first control unit and the host interface is shorter than a data processing time of the second control unit in processing data at the corresponding memory chips.

16. The method of claim 13, further comprising:
allowing the individual sub-control units to manage defective blocks of the corresponding memory chips after performing the error checking/correcting process.
